(19) United States
(12) Patent Application Publication
(10) Pub. No.: US 2010/0297490 A1
(43) Pub. Date: Nov. 25, 2010

(54) NON-AQUEOUS ELECTROLYTE BATTERY

(76) Inventors: Norio TAKAMI, Yokohama-shi (JP); Hiroki Inagaki, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/847,226

(22) Filed: Jul. 30, 2010

Related U.S. Application Data
(63) Continuation of application No. PCT/JP09/54003, filed on Feb. 25, 2009.

(30) Foreign Application Priority Data
Mar. 25, 2008 (JP) 2008-078740

(51) Int. Cl. H01M 2/14

(52) U.S. Cl. 429/131

(57) ABSTRACT

According to one embodiment, a non-aqueous electrolyte battery includes an outer package container, a positive electrode housed in the outer package container and having a positive electrode layer containing an active material, a negative electrode housed in the outer package container and having a negative electrode layer containing lithium-titanium oxide, a separator housed in the outer package container and interposed at least between the positive electrode and the negative electrode, and a non-aqueous electrolyte housed in the outer package container. The separator includes a porous layer made of cellulose, a polyolefin, or a polyamide and an inorganic oxide filler dispersed in the porous layer, and has a porosity of 60 to 80% by volume.

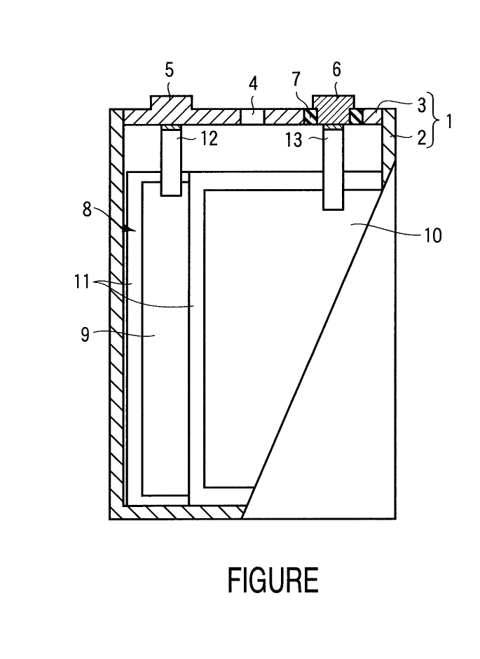

### CROSS-REFERENCE TO RELATED APPLICATIONS

This is a Continuation Application of PCT Application No. PCT/JP2009/054003, filed Feb. 25, 2009, which was published under PCT Article 21(2) in English.

This application is based upon and claims the benefit of priority from Japanese Patent Application No. 2008-078740, filed Mar. 25, 2008, the entire contents of which are incorporated herein by reference.

### FIELD

Embodiments described herein relate generally to a non-aqueous electrolyte battery.

### BACKGROUND

Non-aqueous electrolyte batteries using a lithium metal, lithium alloy, lithium compound or carbonaceous material as the negative electrode active material expects as high-energy density batteries, therefore research and development of the batteries has been carried out. The lithium ion secondary batteries provided with a positive electrode containing LiCoO₂ or LiMn₂O₄ as the active material and a negative electrode containing a carbonaceous material which charges and discharges lithium as the active material have been put to broad use in portable devices.

In a secondary battery like this, materials superior in chemical or electrochemical stability, strength and corrosion resistance are required for the positive electrode, negative electrode, separator and non-aqueous electrolyte. This aims at improvements in storage performance, reliability and safety, and further the basic performances of the battery such as output performance and cycle life under, particularly, a high-temperature environment, when the battery is mounted on vehicles such as automobiles and trains. Further, these materials are desired to have high performances also in cold climate areas and to have high output performance and cycle life under a low-temperature environment (−40° C.). As to the non-aqueous electrolyte, on the other hand, studies are still ongoing to develop a nonvolatile and nonflammable electrolyte solution from the viewpoint of improving safety. However, the non-aqueous electrolyte involves deterioration in output characteristics, low-temperature performance and long-life performance and therefore has not been put into practical use yet.

Therefore, a system using a lithium ion secondary battery mounted on a vehicle and the like poses large problems concerning high-temperature durability and output performance. Particularly, it is difficult to use a lithium ion secondary battery by mounting it in the engine room of a vehicle in place of a lead-acid storage battery.

As a conventional separator, a porous film made of a synthetic resin such as a polyolefin is used. However, this porous film is heat-shrunk and fused under a high-temperature environment (80 to 190° C.), and therefore develops short-circuit failures, leading to lower reliability and safety. To counteract this, some methods have been proposed in which an inorganic insulating layer is newly formed between the separator and the electrode or the separator is formed as an inorganic insulating layer. However, such a separator involves difficulty in attaining durability and output performance at the same time because of an increase in battery resistance and low mechanical strength.

### BRIEF DESCRIPTION OF THE DRAWINGS

The single FIGURE is a partially broken front view showing a non-aqueous electrolyte battery according to an embodiment.

### DETAILED DESCRIPTION

In general, according to one embodiment, a non-aqueous electrolyte battery includes: an outer package container; a positive electrode housed in the outer package container and having a positive electrode layer containing an active material; a negative electrode housed in the outer package container and having a negative electrode layer containing lithium-titanium oxide; a separator housed in the outer package container and interposed at least between the positive electrode and the negative electrode; and a non-aqueous electrolyte housed in the outer package container. The separator comprises a porous layer made of cellulose, a polyolefin, or a polyamide and an inorganic oxide filler dispersed in the porous layer, and has a porosity of 60 to 80% by volume.

Next, the outer package container, negative electrode, positive electrode, separator and non-aqueous electrolyte will be described.

1) Outer Package Container

A metal container or a laminate film container may be used as the outer package container for housing the positive electrode, negative electrode, separator and non-aqueous electrolyte.

The metal container is provided with a metal can having a bottomed prism or cylinder form and a lid secured air-tightly to an opening of the metal can. The metal container is made of aluminum, an aluminum alloy, iron or stainless steel. The outer package container (particularly, a metal can) is designed to have a thickness of preferably 0.5 mm or less and more preferably 0.3 mm or less.

The metal can made of an aluminum alloy is preferably made of an alloy having an aluminum purity of 99.8% by weight or less and containing elements such as Mn, Mg, Zn and Si. The metal can made of an aluminum alloy having such a composition is significantly increased in strength and therefore, the wall thickness of the metal can is further reduced. As a result, a thin type, lightweight and high-output non-aqueous electrolyte battery superior in heat radiation can be attained.

As the laminate film, for example, a multilayer film obtained by interposing an aluminum foil between synthetic resin films may be used. As the synthetic resin, for example, a polypropylene (PP), polyethylene (PE), nylon or polyethylene terephthalate (PET) may be used. The aluminum foil preferably has an aluminum purity of 99.5% by weight or more. The laminate film preferably has a thickness of 0.2 mm or less.

2) Positive Electrode

The positive electrode comprises a current collector and a positive electrode layer formed on one or both surfaces of the current collector and containing an active material, conductive agent and binder.

As the active material, a lithium-metal phosphate compound or a lithium-manganese composite oxide having an olivine structure is preferable. Examples of the lithium-metal phosphate compound may include lithium-iron phosphate (LiₓFePO₄; 0≦x≦1.1), lithium-manganese phosphate (LiₓMnPO₄; 0<x≦1.1), lithium-manganese-iron phosphate (LiₓFe_{1-y}Mn_{y}PO₄; 0<x≦1.1, 0<y<1), lithium-nickel phosphate (LiₓNiPO₄; 0<x≦1.1) and lithium-cobalt phosphate (LiₓCoPO₄; 0<x≦1.1). Examples of the lithium-manganese composite oxide may include lithium-manganese composite oxide (LiₓMn₂PO₄; 0≦x≦1.1) and lithium-manganese-nickel composite oxide (LiₓMn_{1.5}Ni_{0.5}O₄; 0≦x≦1.1) having a spinel structure. The positive electrode containing the positive electrode layer having such an active material can suppress oxidation under a high-temperature atmosphere to thereby suppress the oxidation deterioration of the separator, thereby making it possible to improve the high-temperature durability. Particularly, an active material, LiₓFePO₄ can significantly improve the high-temperature life performance in the electrolyte. This reason for this is that it suppresses the growth of the coating film produced on the surface of the positive electrode when the battery is stored at high temperatures, which decreases a rise in the resistance of the positive electrode when the battery is stored, thereby significantly improving the storage performance under a high-temperature environment.

The positive electrode active material has a primary particle diameter of preferably 1 μm or less and more preferably 0.01 to 0.5 μm. An active material containing primary particles having such a particle diameter can be decreased under the influence of the electron conductivity resistance in the active material and under the influence of diffusion resistance of lithium ions, thereby improving the output performance. Here, these primary particles may be coagulated to form secondary particles having a diameter of 10 μm or less.

The active material preferably has a structure in which carbon microparticles having an average particle diameter of 0.5 μm or less are stuck to the surface thereof. These carbon microparticles are preferably made to adhere to the surface of the active material in an amount of 0.001 to 3% by weight. The positive electrode containing the active material with carbon microparticles stuck thereto in such an amount is reduced in its resistance and in interfacial resistance with the electrolyte, thereby making possible to further improve the output performance.

As the conductive agent, for example, acetylene black, carbon black, graphite or carbon fibers may be used. Particularly, carbon fibers, which have a fiber diameter of 1 μm and are formed by vapor phase growth, are preferable. The use of these carbon fibers ensures that an electron conductive network in the positive electrode can be formed to improve the output performance of the positive electrode significantly.

As the binder, a polytetrafluoroethylene (PTFE), polyvinylidene fluoride (PVdF) or a fluorine-based rubber may be used.

The blending ratio of the active material of the positive electrode, conductive agent and binder is preferably in the following ranges: active material is 80 to 95% by weight, conductive agent is 3 to 19% by weight and binder is 1 to 7% by weight.

The positive electrode is produced, for instance, by suspending the active material, the conductive agent and the binder in an appropriate solvent and the obtained suspension is applied to a current collector, followed by drying and pressing to form a positive electrode layer. The positive electrode layer preferably has a specific surface area of 0.1 to 2 m²/g, when the specific surface area is measured by the BET method using N₂ adsorption.

The current collector is preferably formed of an aluminum foil or an aluminum alloy foil. The thickness of the aluminum foil or aluminum alloy foil is 20 μm or less and more preferably 15 μm or less.

3) Negative Electrode

The negative electrode comprises a current collector and a negative electrode layer formed on one or both surfaces of the current collector and containing an active material, a conductive agent and a binder.

As the active material, lithium-titanium oxide is used. Examples of the lithium-titanium oxide include lithium titanium-oxide, for example, LiₓTiO₂ (x is defined 0≦x), Li₄₊ₓTi₅O₁₂ (x is defined −1≦x≦3) having a spinel structure, Li₂₊ₓTi₃O₇, Li₁₊ₓTi₂O₄, Li_{1.1+x}Ti_{1.8}O₄, Li_{1.07+x}Ti_{1.86}O₄ and LiₓTiO₂ (x is defined 0≦x) which have a ramsdellite structure, and more preferably, Li₂₊ₓTi₃O₇ or Li_{1.1+x}Ti_{1.8}O₄. Examples of the titanium having other crystal structures may include TiO₂. The crystal structure of TiO₂ is preferably a less crystalline one which is an anatase type or bronze type and is heat-treated at 300 to 600° C. Other examples of the lithium-titanium oxide may include titanium-containing metal composite oxides containing Ti and at least one element selected from the group consisting of P, V, Sn, Cu, Ni, Mn and Fe, for example, TiO₂—P₂O₅, TiO₂—V₂O₅, TiO₂—P₂O₅—SnO₂ and TiO₂—P₂O₅-MeO (Me is at least one element selected from the group consisting of Cu, Ni and Fe). This titanium-containing metal composite oxide preferably has low crystallinity and also has a microstructure in which a crystal phase and an amorphous phase coexist or an amorphous phase singly exists. The negative electrode containing the lithium-titanate oxide having such a microstructure makes it possible to significantly improve the cycle performance of the non-aqueous electrolyte battery.

The active material preferably has an average primary particle diameter of 0.001 to 1 μm. When primary particles having an average particle diameter exceeding 1 μm are used to form a negative electrode layer having a specific surface area as large as 3 to 50 m²/g, the porosity of the negative electrode is reduced to less than 20% by volume. When the average particle diameter is less than 0.001 μm, the active material particles tend to coagulate and there is therefore a fear that the non-aqueous electrolyte in the outer package container is distributed disproportionately on the negative electrode, causing a lack of the electrolyte on the positive electrode side.

A favorable performance is obtained when particles of the active material have either a granular or fiber form. In this case, when the active material has a fiber form, the active material preferably has a diameter of 0.1 μm or less.

The active material preferably has an average particle diameter of 1 μm or less and the negative electrode layer containing this active material preferably has a specific surface area of 3 to 200 m²/g when the specific surface area is measured by the BET method using N₂ adsorption. The negative electrode included the negative electrode layer containing an active material having such an average particle diameter and having such a specific surface area can be further increased in the affinity to the non-aqueous electrolyte.

When the specific surface area of the negative electrode layer is less than 3 m²/g, coagulation of the active material particles is generated, leading to a low affinity of the negative electrode to the non-aqueous electrolyte, with the result that the interfacial resistance of the negative electrode increases. This raises the possibility of deterioration in output characteristics and charge-discharge cycle characteristics. When the specific surface area of the negative electrode layer exceeds 200 m²/g, the non-aqueous electrolyte in the outer package container is distributed disproportionately on the negative electrode side, causing a lack of the electrolyte on the positive electrode side, which is a hindrance to an improvement in output characteristics and charge-discharge characteristics. The specific surface area of the negative electrode layer is more preferably 5 to 50 m²/g.

The porosity of the negative electrode layer is preferably 20 to 50% by volume. The negative electrode included the negative electrode layer having such a porosity has high affinity to the non-aqueous electrolyte, enabling high densification. The porosity of the negative electrode layer is more preferably 25 to 40% by volume.

The current collector is preferably made of an aluminum foil or an aluminum alloy foil. The use of a current collector made of an aluminum foil or an aluminum alloy foil enables the prevention of storage deterioration caused by overcharge at high temperatures.

The thickness of the aluminum foil or aluminum alloy foil is preferably 20 μm or less and more preferably 15 μm or less. The aluminum foil preferably has a purity of 99.99% or more. As the aluminum alloy, those containing elements such as Mg, Zn and silicon are preferable. In an aluminum alloy containing transition metals such as Fe, Cu, Ni and Cr, on the other hand, the amount of these transition metals is preferably made to be 100 ppm by weight or less.

Examples of the conductive agent may include acetylene black, carbon black, cokes, carbon fibers, graphite, metal compound powders and metal powders. More preferable examples of the conductive agent may include coke which is heat-treated at 800 to 2000° C., graphite, TiO, TiC and TiN and have an average particle diameter of 10 μm or less or metal powders such as powders of Al, Ni, Cu or Fe.

Examples of the binder may include a polytetrafluoroethylene (PTFE), polyvinylidene fluoride (PVdF), fluorine-based rubber, styrene butadiene rubber and core-shell binder.

The blending ratio of the active material, conductive agent and binder in the negative electrode is preferably in the following ranges: active material is 80 to 95% by weight, conductive agent is 1 to 18% by weight and binder is 2 to 7% by weight.

The negative electrode is produced, for instance, by suspending the aforementioned active material, conductive agent and binder in a proper solvent and the obtained suspension is applied to a current collector, followed by drying and hot-pressing to form a negative electrode layer. In the production of the negative electrode, it is preferable to uniformly disperse the active material particles decreased in the addition amount of the binder. The dispersibility of the active material particles tends to be improved with increase in the addition amount of the binder. On the other hand, the surface of the active material particles is easily covered with the binder and there is therefore a fear that the specific surface area of the negative electrode (negative electrode layer) is decreased. When the addition amount of the binder is small, the active material particles tend to coagulate. To suppress coagulation of the active material particles, the active material particles can be uniformly dispersed by regulating the stirring conditions (rotation rate of a ball mill, stirring time and stirring temperature).

In the production of a negative electrode, the surface of the active material is easily covered with a conductive agent and the number of pores on the surface of the negative electrode (negative electrode layer) tends to decrease when the addition amount of the conductive agent is large even if the addition amount of the binder and the stirring conditions are each in an appropriate range. For this reason, the specific surface area of the negative electrode (negative electrode layer) tends to decrease. When the addition amount of the conductive agent is small on the other hand, there is a tendency for the active material to be easily crushed, causing an increase in the specific surface area of the negative electrode (negative electrode layer) or a deterioration in the dispersibility of the active material, causing a reduction in the specific surface area of the negative electrode layer. The specific surface area of the negative electrode layer in the negative electrode to be produced is affected not only by the addition amount of the conductive agent but also by the average particle diameter and specific surface area of the conductive agent. The conductive agent preferably has a larger average particle diameter than the active material and a larger specific surface area than the active material.

In the case of fully charging, particularly at high temperatures, by using the aforementioned positive electrode and negative electrode, it is preferable that the positive electrode layer should be covered on the facing negative electrode layer such that it is extended beyond the surface of the negative electrode layer. With such a structure, the potential of the positive electrode layer positioned at the edge part can be made to be the same as the potential of the positive electrode layer facing the negative electrode layer at the center part, and it is therefore possible to suppress the reaction of the positive electrode material of the edge part with the non-aqueous electrolyte caused by overcharge. When the negative electrode layer is covered on the positive electrode layer, on the contrary, the potential of the positive electrode layer positioned at the edge part is affected by the negative electrode potential of the unreacted part of the negative electrode active material protruded from the positive electrode, and therefore the positive electrode layer positioned at the edge part is put into an overcharged state when the battery is fully charged, raising a fear that the life performance is significantly reduced. It is therefore preferable for the area of the positive electrode layer to be larger than the area of the negative electrode layer and both the electrode layers to be coiled or laminated such that the positive electrode facing the negative electrode is protruded from the negative electrode to constitute an electrode group.

Specifically, when the areas of the above positive electrode layer and negative electrode layer are Sp and Sn respectively, the ratio of these areas (Sn/Sp) is preferably 0.85 to 0.999. When Sn/Sp exceeds 0.999, there is a fear that gas generated from the negative electrode is decreased in high-temperature charge storage time and high-temperature float charging, thereby deteriorating the storage performance. When Sn/Sp is less than 0.85 on the other hand, there is a fear that battery capacity is reduced. The ratio Sn/Sp is more preferably 0.95 to 0.99. When the width of the positive electrode is Lp and the width of the negative electrode is Ln at this area ratio, the ratio of these widths (Ln/Lp) is preferably 0.9 to 0.99. Here, the widths of the positive electrode and negative electrode respectively indicate the length in a direction perpendicular to the direction of the coil in, for example, the spiral electrode group.

4) Separator

The separator is interposed between the positive electrode and the negative electrode. The separator comprises a porous layer made of cellulose, a polyolefin or a polyamide and an inorganic oxide filler which is dispersed in and supported on the porous layer and has a porosity of 60 to 80% by volume. Such a separator suppresses the occurrence of a phenomenon of short circuits across the positive electrode and the negative electrode even if components such as cellulose are heat-shrunk or put into a molten state under a high-temperature environment of 80° C. to 190° C., thereby making it possible to maintain high reliability.

Here, the porosity (pore ratio) of the separator may be measured, for example, by the following methods.

After a separator sample cut into a size of 25×77 cm is dried (80° C., vacuum, 12 hours), its weight and thickness are measured to find the bulk density. The porosity can be determined from the ratio of the determined bulk density to the true density. Further, the porosity can be also determined from the measurement of the pore distribution by using mercury porosimetry. For example, the separator having the above size is set to an automatic porosimeter auto pore IV9500 (produced by Shimadzu Corporation) to determine pore distribution and the porosity can be measured from the obtained total pore volume.

Examples of the polyolefin as the porous layer component may include a polyethylene, polypropylene and mixtures of a polypropylene and a polyethylene.

As the inorganic oxide filler, for example, a particle of at least one inorganic oxide selected from the group consisting of alumina, silica, titania, magnesia and zirconia may be used. This granular inorganic oxide filler has an average particle diameter of, preferably, 1 μm or less and more preferably 0.1 to 1 μm. If such a granular inorganic oxide filler is used, the dispersing the inorganic oxide filler in the porous layer is easily accomplished, and also, a separator having high insulating ability can be obtained. When the average particle diameter of the granular inorganic oxide filler exceeds 1 μm, there is a fear that the porosity becomes less than the lower limit (60%) of the intended porosity.

The inorganic oxide filler is preferably dispersed in a ratio of 10 to 90% by weight based on the total amount of the porous layer and inorganic oxide filler. In the formulation of the inorganic oxide filler added in such an amount, the thickness of the porous layer (substantially, the thickness of the separator) is designed to be, for example, 20 to 50 μm, enabling the production of a separator having a porosity as high as 60 to 80% and sufficient strength. When the proportion of the inorganic oxide filler to be formulated is less than 10% by weight, there is a fear that it is difficult to sufficiently attain the effect obtained by formulating the inorganic oxide filler, that is, the effect of securing electronic insulation between the positive electrode and the negative electrode under a high-temperature environment. If the proportion of the inorganic oxide filler to be formulated exceeds 90% by weight, on the other hand, there is fear that the flexibility and strength of the porous layer (substantially, the separator) are lowered, and it is therefore difficult to maintain a porosity range from 60 to 80%. It is further desirable to disperse the inorganic oxide filler in a ratio of 30 to 60% by weight based on the total amount of the porous layer and the inorganic oxide filler.

When the porosity of the separator is designed to be in a range from 60 to 80% by volume, a sufficient amount of the non-aqueous electrolyte can be kept, with the result that a non-aqueous electrolyte battery reduced in internal resistance can be attained. The porosity is more preferably 70 to 80% by volume.

Such a separator may be produced, for example, using the following method.

(1) Production of a Separator Provided with a Porous Layer Made of Cellulose

Cellulose and an inorganic oxide filler are dispersed in water, and then the obtained dispersion is subjected to a paper-making process using paper-making technologies to produce a separator which comprises a porous layer made of the cellulose and the inorganic oxide filler dispersed in this porous layer and has a porosity of 60% to 80% by volume.

(2) Production of a Separator Provided with a Porous Layer Made of a Polyolefin or Polyamide

After a polyolefin or polyamide and an inorganic oxide filler are dissolved in a solvent, the dissolved mixture is made into a film having a desired thickness. This film is stretched while vaporizing (volatilization) the solvent to thereby form pores primarily at positions where the solvent is dispersed. As a result, a separator which comprises a porous layer (microporous resin film having a number of open pores) made of polyolefin or polyamide and the inorganic oxide filler dispersed in this porous layer and has a porosity of 60% to 80% by volume, is produced.

5) Non-Aqueous Electrolyte

Examples of the non-aqueous electrolyte include liquid organic electrolytes prepared by dissolving an electrolyte in an organic solvent, gel-like organic electrolytes obtained by forming a composite of a liquid organic solvent and a high-molecular material and solid non-aqueous electrolytes obtained by forming a composite of a lithium salt electrolyte and a high-molecular material. Also, a cold molten salt (ionic melt) may be used as the non-aqueous electrolyte. Examples of the high-molecular material may include a polyvinylidene fluoride (PVdF), polyacrylonitrile (PAN) and polyethylene oxide (PEO).

In the case of the liquid organic electrolyte, an electrolyte is dissolved in an organic solvent at a concentration of 0.5 to 2.5 mol/L.

Examples of the electrolyte may include LiBF₄, LiPF₆, LiAsF₆, LiClO₄, LiCF₃SO₃, LiN(CF₃SO₂)₂, LiN(C₂F₅SO₂)₂, Li(CF₃SO₂)₃C and LiB[(OCO)₂]₂. These electrolytic salts may be used alone or in combinations of two or more. The electrolyte preferably contains lithium tetrafluoroborate (LiBF₄) in particular. Because this lithium tetrafluoroborate has high chemical stability with organic solvents and the coating resistance on the negative electrode can be reduced, the low-temperature performance and cycle life of the battery can be significantly improved.

Examples of the organic solvent may include cyclic carbonates such as propylene carbonate (PC) and ethylene carbonate (EC); chain carbonates such as diethyl carbonate (DEC), dimethyl carbonate (DMC) or methylethyl carbonate (MEC); chain ethers such as dimethoxyethane (DME) and diethoxyethane (DEE); cyclic ethers such as tetrahydrofuran (THF) and dioxolan (DOX); and other solvents including γ-butyrolactone (GBL), acetonitrile (AN) and sulfolane (SL). These solvents may be used alone or in combinations of two or more. Of these solvents, organic solvents containing propylene carbonate (PC), ethylene carbonate (EC) or γ-butyrolactone (GBL) improve the thermal stability even if the boiling point is 200° C. or higher and are therefore preferable. Particularly, an organic solvent containing γ-butyrolactone (GBL) improves the output performance under a low-temperature environment and is therefore preferable. Also, the organic solvent can dissolve any excess, during use, of lithium salt.

The electrolyte is preferably dissolved in an amount of 1.5 to 2.5 mol/L in the organic solvent. A liquid organic electrolyte having such a concentration makes it possible to draw high output power under a low-temperature environment. When the concentration of the electrolyte is less than 1.5 mol/L, there is a fear that the concentration of lithium ions at the boundary between the positive electrode and the organic electrolyte is rapidly decreased, bringing about a reduction in output. When the concentration of the electrolyte exceeds 2.5 mol/L, on the other hand, there is a fear that the viscosity of the electrolyte is increased, which reduces the transfer speed of lithium ions, resulting in reduced output power.

The cold molten salt (ionic melt) is preferably constituted of lithium ions, organic cations and organic anions. Also, the cold molten salt is preferably a liquid at ambient temperature or lower.

An electrolyte containing the cold molten salt will be described.

The term cold molten salt refers to a salt at least a part of which exhibits a liquid state, and the word cold refers to a temperature range in which a power source is assumed to ordinarily work. The temperature range in which a power source is assumed to ordinarily work means a range in which the upper limit is about 120° C. and, according to the case, about 60° C. and the lower limit is about −40° C. and according to the case, about −20° C. Particularly, a temperature in a range of −20° C. to 60° C. is preferable.

As the cold molten salt containing lithium ions, an ionic melt constituted of lithium ions, organic cations and anions is preferably used. Also, this ionic melt is preferably a liquid even at an ambient temperature or lower.

Examples of the above organic cations may include alkylimidazolium ions and quaternary ammonium ions having a skeleton represented by —N⁺—.

The alkylimidazolium ion is preferably, for example, a dialkylimidazolium ion, trialkylimidazolium ion or tetraalkylimidazolium ion. The dialkylimidazolium ion is preferably, for example, a 1-methyl-3-ethylimidazolium ion (MEI⁺). The trialkylimidazolium ion is preferably, for example, a 1,2-diethyl-3-propylimidazolium ion (DMPI⁺). The tetraalkylimidazolium ion is preferably, for example, a 1,2-diethyl-3,4(5)-dimethylimidazolium ion.

The quaternary ammonium ion is preferably, for example, a tetraalkylammonium ion or cyclic ammonium ion. The tetraalkylammonium ion is preferably, for example, a dimethylethylmethoxyethylammonium ion, dimethylethylmethoxymethylammonium ion, dimethylethylethoxyethylammonium ion or trimethylpropylammonium ion.

The melting point can be lowered to 100° C. or lower and preferably 20° C. or lower by using alkylimidazolium ions or quaternary ammonium ions (particularly, tetraalkylammonium ions). Moreover, the reactivity with the negative electrode can be reduced.

The concentration of lithium ions is preferably 20 mol % or less and more preferably 1 to 10 mol %. If the concentration of lithium ions is in this range, a liquid cold molten salt can be formed at a temperature as low as 20° C. or lower with ease. Also, the viscosity can be reduced even at an ambient temperature or lower, and therefore the ionic conductivity can be increased.

As the anion, one or more types selected from the group consisting of BF₄⁻, PF₆⁻, AsF₆⁻, ClO₄⁻, CF₃SO₃⁻, CF₃COO⁻, CH₃COO⁻, CO₃²⁻, (FSO₂)₂N⁻, N(CF₃SO₂)₂⁻, N(C₂F₅SO₂)₂⁻ and (CF₃SO₂)₃C⁻ are preferable. A cold molten salt having a melting point of 20° C. or lower can be easily formed when a plurality of anions coexist. The anions are more preferably BF₄⁻, (FSO₂)₂N⁻, CF₃SO₃⁻, CF₃COO⁻, CH₃COO⁻, CO₃²⁻, N(CF₃SO₂)₂⁻, N(C₂F₅SO₂)₂⁻ and (CF₃SO₂)₃C⁻. These anions make it easy to form a cold molten salt having a melting point of 0° C. or lower.

Next, an example of a thin type rectangular non-aqueous electrolyte battery according to the embodiment will be described in detail with reference to the FIGURE. The FIGURE is a partly broken elevation view showing the non-aqueous electrolyte battery according to the embodiment.

A rectangular outer package container 1 is constituted of a rectangular (angular type) metal can (e.g., aluminum can) 2 also serving as a positive electrode terminal and a rectangular lid 3 made of, for example, aluminum which is attached airtightly to an opening of this metal can 2 by welding. A vent 4 is opened at the center of the lid 3. A metal thin film (e.g., an aluminum thin film, though not shown) is attached to the vent 4 and the lower surface of the lid 3 in the vicinity thereof. When the pressure of gas in the outer package container 1 exceeds a fixed value, the metal thin film is broken to release the gas out of the outer package container 1. The rectangular positive electrode terminal 5 is projected towards, for example, the left side of the external surface of the lid 3 from the vent 4 in such a manner as to be integrated with the lid 3. A sectionally T-shaped negative electrode terminal 6 is fixed in a rectangular insulation ring 7 of the lid 3 positioned, for example, on the right side of the vent 4 and secured airtightly to the ring 7.

A flat, spiral electrode group 8 is housed in the metal can 2. The electrode group 8 is produced by sandwiching separators 11 between a positive electrode 9 and a negative electrode 10 and by coiling these electrodes spirally such that the separator 11 is positioned on the outer peripheral surface, followed by press-molding. The positive electrode 9 is constituted of a current collector made of aluminum and a positive electrode layer formed on both sides of the current collector. The negative electrode 10 is constituted of a current collector made of aluminum and a negative electrode layer formed on both sides of the current collector. This separator 7 comprises a porous layer made of cellulose, polyolefin or polyamide and an inorganic oxide filler dispersed in the porous layer and has a porosity of 60 to 80% by volume. The non-aqueous electrolyte solution is housed in the metal can 2.

One end of a belt-shaped positive electrode lead 12 made of, for example, aluminum is electrically connected to the current collector of the positive electrode 9 and the other end is electrically connected with the lower surface of the lid 3 immediately under the positive electrode terminal 5 by welding or the like. One end of a belt-shaped negative electrode lead 13 made of, for example, aluminum is electrically connected to the current collector of the negative electrode 10 and the other end is electrically connected with the lower end surface of the negative electrode terminal 6 exposed from the lower surface of the lid 3 by welding or the like.

According to the embodiment mentioned above, since a separator is provided which is a composite material including a porous layer made of cellulose, polyolefin or polyamide and an inorganic oxide filler dispersed in the porous layer and has a porosity of 60 to 80% by volume, the inorganic oxide filler combined with the porous layer ensures electrical insulation between the positive electrode and the negative electrode even if the porous layer in the separator is heat-shrunk and is put into a molten state under a high-temperature environment of 80° C. to 190° C. Therefore, a non-aqueous electrolyte battery can be obtained which is suppressed in the development of a short circuit phenomenon across the positive electrode and the negative electrode, and maintains high reliability.

Also, since the separator includes a porous layer made of cellulose, polyolefin or polyamide and an inorganic oxide filler dispersed in the porous layer, it can maintain high strength even if it has a porosity as high as 60 to 80%. A separator having such a high porosity can retain a sufficient amount of the non-aqueous electrolyte and also can be reduced in internal resistance. It is therefore possible to obtain a non-aqueous electrolyte battery having a high output performance.

Moreover, the decomposition of the electrolyte solution at the negative electrode under a high-temperature environment is suppressed and the clogging of the separator caused by decomposed products can be prevented by combining the negative electrode containing lithium-titanium oxide as the active material with the separator comprising the porous layer and the inorganic oxide filler dispersed in the porous layer. As a result, the high porosity (60 to 80%) of the separator can be maintained so that a sufficient amount of the electrolyte can be retained under a high-temperature environment, and also, the internal resistance can be reduced, whereby a non-aqueous electrolyte battery having a high output performance can be obtained.

Further, when lithium is charged, the inorganic oxide filler in the separator can prevent from reacting with the active material by using a lithium-titanium oxide as the active material of the negative electrode. As a result, a non-aqueous electrolyte battery decreased in the deterioration of the performance even when it is stored at high temperatures can be obtained.

Therefore, although it is currently difficult to use a non-aqueous electrolyte battery such as a lithium ion battery under a high-temperature environment because of the problems concerning reliability, safety, output and life performance, the combination of a separator which is constituted of a specific structure and high porosity and a negative electrode containing a lithium-titanium oxide as the active material as mentioned in the above embodiment enables the provision of an aqueous electrolyte battery superior in storage durability and output performance under a high-temperature environment.

Moreover, the positive electrode containing, as the active material, a lithium-phosphorous metal compound having an olivine structure or a lithium-manganese oxide having a spinel structure, and particularly, lithium-iron phosphate (LiₓFePO₄, 0≦x≦1.1) is combined in addition to the combination of the separator which is constituted of a specific structure and high porosity and the negative electrode containing a lithium-titanium oxide as the active material, whereby the reaction of the positive and negative electrodes with the electrolyte solution is suppressed, so that a rise in the resistance at the boundary between the positive electrode and the negative electrode when the battery is stored at high temperatures can be suppressed.

Further, the organic electrolyte having a boiling point of 200° C. or, higher or, cold molten salt which is used as the above non-aqueous electrolyte is reduced in vapor pressure and in the generation of gas, and therefore the durability and life performance under a high-temperature environment can be improved in the case of using this non-aqueous electrolyte battery as a power source in vehicles.

### EXAMPLES

The present invention will be described in detail by way of examples with reference to the aforementioned FIGURE. However, the present invention is not limited by the following examples.

### Example 1

### Production of a Positive Electrode

An olivine structured lithium-iron phosphate (LiFePO₄) in which carbon microparticles (average particle diameter: 0.005 μm) was deposited on the surface in deposition amount of 0.1% by weight, and having an average primary particle diameter of 0.1 μm was prepared as a positive electrode active material. 87 parts by weight of this active material, 3 parts by weight of carbon fibers, which were produced by the vapor phase deposition method, having a fiber diameter of 0.1 μm and 5 parts by weight of a graphite powder as conductive agents and 5 parts by weight of PVdF as a binder, were dispersed in a n-methylpyrrolidone (NMP) solvent to prepare a slurry. The obtained slurry was applied to both surfaces of a 15-μm-thick aluminum alloy foil (purity: 99%) as a current collector, followed by drying and pressing to produce a positive electrode in which the thickness of the positive electrode layer on one surface was 43 μm and had a density of 2.2 g/cm³. The specific surface area of the positive electrode layer was 5 m²/g. After that, a band-shaped positive electrode lead made of aluminum was welded to an aluminum alloy foil (current collector) to electrically connect them.

<Production of a Negative Electrode>

A spinel type lithium-titanium oxide (Li_{4/3}Ti_{5/3}O₄) having an average primary particle diameter of 0.3 μm, a BET specific surface area of 15 m²/g and a lithium charge potential of 1.55V (vs. Li/Li⁺) was prepared as a negative electrode active material. This active material, a graphite powder having an average particle diameter of 6 μm as a conductive agent and PVdF used as a binder were formulated in a ratio of 95:3:2 and dispersed in a n-methylpyrrolidone (NMP) solvent. The obtained dispersion was stirred at 1000 rpm for 2 hours by using a ball mill to prepare a slurry. The obtained slurry was applied to both surfaces of a 15-μm-thick aluminum alloy foil (purity: 99.3%) as a current collector, followed by drying and pressing to produce a negative electrode in which the thickness of the negative electrode layer on one surface was 59 μm and had a density of 2.2 g/cm³. The porosity of the negative electrode layer was 35% by volume. Also, the BET specific surface area (surface area per 1 g of the negative electrode layer) of the negative electrode layer was 10 m²/g. After that, a band-shaped negative electrode lead made of aluminum was welded to an aluminum alloy foil (current collector) to electrically connect them.

The method for measuring the particle diameter of the negative electrode active material particles will be described below.

The particle diameter of the negative electrode active material particles was measured using a laser diffraction type distribution measuring device (trade name: SALD-300, produced by Shimadzu Corporation) in the following manner. First, a beaker was charged with about 0.1 g of a sample, a surfactant and 1 to 2 mL of distilled water and the mixture was thoroughly stirred. Then, the mixture was poured into a stirring water bath to measure the luminous distribution 64 times at intervals of 2 seconds to analyze the data of grain size distribution.

The BET specific surface areas of the negative electrode active material and negative electrode by using N₂ adsorption were measured under the following conditions.

1 g of the powder negative electrode material or two of the negative electrodes cut into a size of 2×2 cm² were used as a sample. As the device for measuring the BET specific surface area, a product from Yuasa Ionics Inc. was used and nitrogen gas was used as the adsorption gas.

The porosity of the negative electrode (negative electrode layer) was determined by comparing the volume of the negative electrode layer actually obtained with the volume of the negative electrode layer obtained when the porosity was 0% by volume, and calculating an increase volume from the volume of the negative electrode layer obtained when the porosity was 0% by volume as the volume of voids. The volume of the negative electrode layer was the sum of the volumes of the negative electrode layers formed on both surfaces.

On the other hand, a separator in which 40% by weight of alumina particles having an average particle diameter of 0.3 μm were carried on a fine network of a porous layer made of a polyethylene 30 μm in thickness and having a porosity of 70% by volume was prepared. The separator was closely covered with the above positive electrode and the above negative electrode was overlapped on the separator in such a manner as to face the positive electrode, and the obtained laminate was coiled spirally to produce an electrode group. At this time, the ratio (Sn/Sp) of the area (Sp) of the negative electrode layer of the negative electrode to the area (Sp) of the positive electrode layer of the positive electrode was set to 0.98 and both the layers were disposed such that the positive electrode layer was covered on the negative electrode layer with the separator being interposed therebetween. In succession, the electrode group was subjected to hot-pressing at 80° C. under a pressure of 25 kg/cm² to produce a flat, spiral electrode group. At this time, the width (Lp) of the positive electrode layer was 51 mm and the width (Ln) of the above negative electrode layer was 50 mm, the ratio Ln/Lp being 0.98.

Next, the electrode group was further pressed to be molded into a flat shape, and then housed in a rectangular metal can made of a 0.5 mm-thick aluminum alloy (Al purity: 99%). A non-aqueous electrolyte solution was injected into the rectangular metal can to house it. The non-aqueous electrolyte solution was prepared by blending propylene carbonate (PC), γ-butyrolactone (BL) and ethylene carbonate (EC) in a volumetric ratio of 30:40:30 to form a mixed solvent and by dissolving the mixed solvent in 2.0 mol/L of lithium tetrafluoroborate (LiBF₄). The electrolyte solution had a boiling point of 220° C. In succession, an aluminum rectangular lid is disposed on the opening of the metal can in such a manner that the positive electrode terminal of the lid was positioned outside of the metal can. The positive electrode lead connected to the positive electrode of the electrode group in the metal can was welded to the lid at a position immediately under the positive electrode terminal by ultrasonic welding, and the negative electrode lead connected to the negative electrode of the electrode group was welded to the negative electrode terminal exposed from the lower surface of the lid by ultrasonic welding. Thereafter, the lid was fitted in an opening of the metal can, and the outer periphery of the lid was welded to the opening part of the metal can by laser welding to assemble a thin type non-aqueous electrolyte battery which had the structure shown in the FIGURE and had a thickness of 16 mm, a width of 40 mm and a height of 60 mm.

### Examples 2 to 11 and Comparative Examples 1 to 5

15 types of thin non-aqueous electrolyte batteries were assembled using the same methods as in the aforementioned Example 1 except that the separators, positive electrode active materials and negative electrode active materials shown in the following Table 1 were used. All of the inorganic fillers dispersed in the porous layer were particles having an average particle diameter of 0.3 μm.

The non-aqueous electrolyte batteries obtained in Examples 1 to 11 and Comparative Examples 1 to 5 were each charged up to 2.8V at 25° C. under a current of 6 A for 6 minutes and then discharged to 1.5V under a current of 3 A to measure the discharge capacity. Also, the maximum output of each of these batteries for 10 seconds in 50% charged state was measured. After that, the battery was allowed to fully charge, and then the temperature of the battery was raised at a rate of 5° C./min. up to 200° C., to perform a high-temperature durability test for measuring the surface temperature of the battery and battery voltage.

The results of these tests are shown in the following Table 2.

TABLE 1

| | Separator | | | | | |
|---|---|---|---|---|---|---|
| | | Inorganic filler | | | | |
| | | (particles) | | | Positive | Negative |
| | | | Amount to be | | electrode | electrode |
| | | | blended (% by | Porosity | active | active |
| | Porous layer | Material | weight) | (%) | material | material |
| Example 1 | Polyethylene | Alumina | 40 | 70 | LiFePO₄ | Li₄Ti₅O₁₂ |
| Example 2 | Polyethylene | Silica | 40 | 70 | LiFePO₄ | Li₄Ti₅O₁₂ |
| Example 3 | Polyethylene | Titania | 40 | 70 | LiMn₂O₄ | Li₄Ti₅O₁₂ |
| Example 4 | Polyethylene | Zirconia | 40 | 70 | LiFePO₄ | Li₄Ti₅O₁₂ |
| Example 5 | Polyethylene | Alumina | 60 | 80 | LiMn₂O₄ | Li₄Ti₅O₁₂ |
| Example 6 | Polyethylene | Alumina | 40 | 70 | LiMn₂O₄ | Li₄Ti₅O₁₂ |
| Example 7 | Polyethylene | Alumina | 30 | 60 | LiMn₂O₄ | Li₄Ti₅O₁₂ |
| Example 8 | Polypropylene | Alumina | 40 | 70 | LiMn₂O₄ | Li₄Ti₅O₁₂ |
| Example 9 | Cellulose | Alumina | 40 | 70 | LiMn₂O₄ | Li₄Ti₅O₁₂ |
| Example 10 | Polyamide | Alumina | 40 | 70 | LiMn₂O₄ | Li₄Ti₅O₁₂ |
| Example 11 | Polyethylene | Alumina | 40 | 70 | LiCoO₂ | Li₄Ti₅O₁₂ |
| Comparative | Polyethylene | None | | 50 | LiCoO₂ | Graphite |
| Example 1 | | | | | | |
| Comparative | Polypropylene | None | | 50 | LiMn₂O₄ | Graphite |
| Example 2 | | | | | | |
| Comparative | Cellulose | None | | 70 | *1 | Graphite |
| Example 3 | | | | | | |
| Comparative | Polyethylene | None | | 50 | LiCoO₂ | Hard |
| Example 4 | | | | | | carbon |
| Comparative | Polyvinylidene | Alumina | 97 | 40 | LiCoO₂ | Graphite |
| Example 5 | fluoride | | | | | |

The positive electrode active material of *1 is LiNi_{1/3}Mn_{1/3}CO_{1/3}O₂.

TABLE 2

| | | | 200° C. temperature rise test | |
|---|---|---|---|---|
| | Discharge | Output at | Surface | Battery |
| | capacity at | 25° C. | temperature | voltage |
| | 25° C. (mAh) | (W) | of the battery (° C.) | (V) |
| Example 1 | 3000 | 250 | 200 | 1.0 |
| Example 2 | 3000 | 250 | 200 | 1.0 |
| Example 3 | 3100 | 350 | 205 | 0.8 |
| Example 4 | 3000 | 250 | 200 | 1.0 |
| Example 5 | 3100 | 400 | 205 | 1.2 |
| Example 6 | 3100 | 350 | 200 | 1.0 |
| Example 7 | 3100 | 320 | 215 | 0.8 |
| Example 8 | 3100 | 350 | 205 | 1.1 |
| Example 9 | 3100 | 350 | 200 | 0.8 |
| Example 10 | 3100 | 350 | 200 | 1.2 |
| Example 11 | 3300 | 360 | 220 | 0.8 |
| Comparative | 3100 | 200 | 500 | 0 |
| Example 1 | | | | |
| Comparative | 3200 | 200 | 350 | 0 |
| Example 2 | | | | |
| Comparative | 3300 | 150 | 360 | 0 |
| Example 3 | | | | |
| Comparative | 3300 | 150 | 450 | 0.5 |
| Example 4 | | | | |
| Comparative | 3300 | 200 | 500 | 0.5 |
| Example 5 | | | | |

As is clear from the above Tables 1 and 2, each non-aqueous electrolyte battery obtained in Examples 1 to 11 is more resistant to the occurrence of short circuits under a high-temperature environment and is further reduced in heat generation than each non-aqueous electrolyte battery obtained in Comparative Examples 1 to 5. Moreover, each non-aqueous electrolyte battery obtained in Examples is superior in output performance. It is found that particularly the non-aqueous electrolytes obtained in Examples 5, 6, 9 and 11 each have superior output performance.

Each of the above embodiments as it stands is not described to limit the present invention and the structural elements may be modified and embodied without departing from the spirit of the present invention in the practical stage of the present invention. Also, various inventions can be made by a proper combination of a plurality of structural elements disclosed in the above embodiments. For instance, some structural elements may be eliminated from the structural elements shown in these embodiments. Moreover, the structural elements used in different embodiments may be appropriately combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-aqueous electrolyte battery comprising:
an outer package container;
a positive electrode housed in this outer package container and having a positive electrode layer containing an active material;
a negative electrode housed in the outer package container and having a negative electrode layer containing lithium-titanium oxide as an active material;
a separator housed in the outer package container and interposed at least between the positive electrode and the negative electrode; and
a non-aqueous electrolyte housed in the outer package container,
wherein the separator comprises a porous layer made of cellulose, a polyolefin, or a polyamide and an inorganic oxide filler dispersed in the porous layer, and has a porosity of 60 to 80% by volume.

2. The battery of claim 1, wherein the porous layer has a porosity of 70 to 80% by volume.

3. The battery of claim 1, wherein the inorganic oxide filler is a particle of at least one inorganic oxide selected from the group consisting of alumina, silica, titania, magnesia and zirconia.

4. The battery of claim 1, wherein the inorganic oxide filler is a particle having an average particle diameter of 1 μm or less.

5. The battery of claim 1, wherein the inorganic oxide filler is a particle having an average particle diameter of 0.1 to 1 μm.

6. The battery of claim 1, wherein the inorganic oxide filler is dispersed in the porous layer in a ratio of 10 to 90% by weight based on the total amount of the porous layer and the inorganic oxide filler.

7. The battery of claim 1, wherein the inorganic oxide filler is dispersed in the porous layer in a ratio of 30 to 60% by weight based on the total amount of the porous layer and the inorganic oxide filler.

8. The battery of claim 1, wherein the porous layer has a thickness of 20 to 50 μm.

9. The battery of claim 1, wherein the lithium-titanium oxide is a lithium-titanium oxide having a spinel structure, an anatase structure, a bronze structure or a ramsdellite structure.

10. The battery of claim 1, wherein the negative electrode layer has a porosity of 20 to 50% by volume.

11. The battery of claim 1, wherein the active material of the positive electrode is a lithium-phosphorous metal compound having an olivine structure or a lithium-manganese composite oxide having an olivine structure.

12. The battery of claim 11, wherein the lithium-phosphorous metal compound is lithium-iron phosphate.

13. The battery of claim 1, wherein the area ratio Sn/Sp, where Sp represents the area of the positive electrode layer and Sn represents the area of the negative electrode layer, is 0.85 to 0.999.

14. The battery of claim 13, wherein the width ratio Ln/Lp, where Lp represents the width of the positive electrode layer and Ln represents the width of the negative electrode layer, is 0.85 to 0.99.
